(19) United States
(12) Patent Application Publication
(10) Pub. No.: US 2005/0195998 A1
(43) Pub. Date: Sep. 8, 2005

(54) Simultaneous audio playback device

(75) Inventors: Eiji Yamamoto, Saitama (JP); Takao Takahashi, Tokyo (JP); Shinichi Maru, Chiba (JP); Hideyuki Uemura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/052,032

(22) Filed: Feb. 8, 2005

(30) Foreign Application Priority Data
Mar. 3, 2004 (JP) 2004-059476

(51) Int. Cl. H04B 1/00; H04R 3/00

(52) U.S. Cl. 381/119; 381/98; 381/111

(57) ABSTRACT

This invention allows a plurality of users to listen to different sounds at high sound quality. This invention provides a selector 16 for selecting audio signals corresponding to requests from a plurality of users, headphone amplifiers 17A and 17B for individually outputting the selected audio signals to the corresponding users, and the speaker amplifier 20 for outputting a mixed bass signal created by extracting and mixing only the bass components of the selected audio signals, to all the users. As a result, each of the users can listen to different desired sound in a situation where the bass components of the users' desired sounds are mixed and output to all the users.

### BACKGROUND OF THE INVENTION

1. Field of the Invention

This invention relates to a simultaneous audio playback device and, more particularly, is suitably applied to a vehicle audio device capable of allowing a plurality of users to listen to different sounds from different audio sources.

2. Description of the Related Art

Vehicle audio devices mounted in vehicles generally let all users in a vehicle listen to the same sounds by amplifying an audio signal from an audio source such as radio or a compact disc (CD).

Some vehicle audio devices can allow users to listen to different sounds from different audio sources via headphones (for example, refer to Japanese Patent Laid-open No. 2003-89331).

These vehicle audio devices, however, have a sound quality problem because headphone's bass output is insufficient due to its characteristics.

### SUMMARY OF THE INVENTION

This invention has been made in view of foregoing and proposes a simultaneous audio playback device which is capable of allowing a plurality of users to listen to different sounds with high sound quality.

The foregoing object and other objects of the invention have been achieved by the provision of a simultaneous audio playback device. This device comprises: an audio signal selection means for selecting audio signals corresponding to requests from plural users, out of plural kinds of audio signals; individual audio signal output means for individually outputting the selected audio signals to the corresponding users; and a mixed bass signal output means for outputting a mixed bass signal created by extracting and mixing only the bass components of the selected audio signals, to all the users.

Further, this invention provides a simultaneous audio playback method comprising: an audio signal selection step of selecting audio signals corresponding to requests from plural users, out of plural kinds of audio signals; an individual audio signal output step of individually outputting the selected audio signals to the corresponding users; and a mixed bass signal output step of outputting a mixed bass signal created by extracting and mixing only the bass components of the selected audio signals, to all the users.

Still further, this invention provides a simultaneous audio playback system comprising: an audio signal selection means for selecting audio signals corresponding to requests from plural users, out of plural kinds of audio signals; individual audio signal output means for individually outputting the selected audio signals to the corresponding users; a mixed bass signal output means for outputting a mixed bass signal created by extracting and mixing only the bass components of the selected audio signals, to all the users; individual audio output means for individually outputting the selected audio signals as sound; and a mixed bass output means for outputting the mixed bass signal as sound.

Still further, this invention provides a vehicle comprising: an audio signal selection means for selecting audio signals corresponding to requests from plural users, out of plural kinds of audio signals; individual audio signal output means for individually outputting the selected audio signals to the corresponding users; a mixed bass signal output means for outputting a mixed bass signal created by extracting and mixing only the bass components of the selected audio signals, to all the users; individual audio output means for individually outputting the selected audio signals as sound; and a mixed bass output means for outputting the mixed bass signal as sound.

According to this invention, users can listen to different audio signals in a situation where the bass components of the audio signals are mixed and output to all the users, thus making it possible to realize a simultaneous audio playback device capable of allowing plural users to listen to different sounds with higher sound quality.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic diagram of a simultaneous audio playback system according to this invention;

FIG. 2 is a block diagram of a simultaneous audio playback device according to this invention; and

FIG. 3 is a block diagram of a simultaneous audio playback system according to another embodiment.

### DETAILED DESCRIPTION OF THE EMBODIMENT

Preferred embodiments of this invention will be described with reference to the accompanying drawings:

(1-1) Construction of Simultaneous Audio Playback System

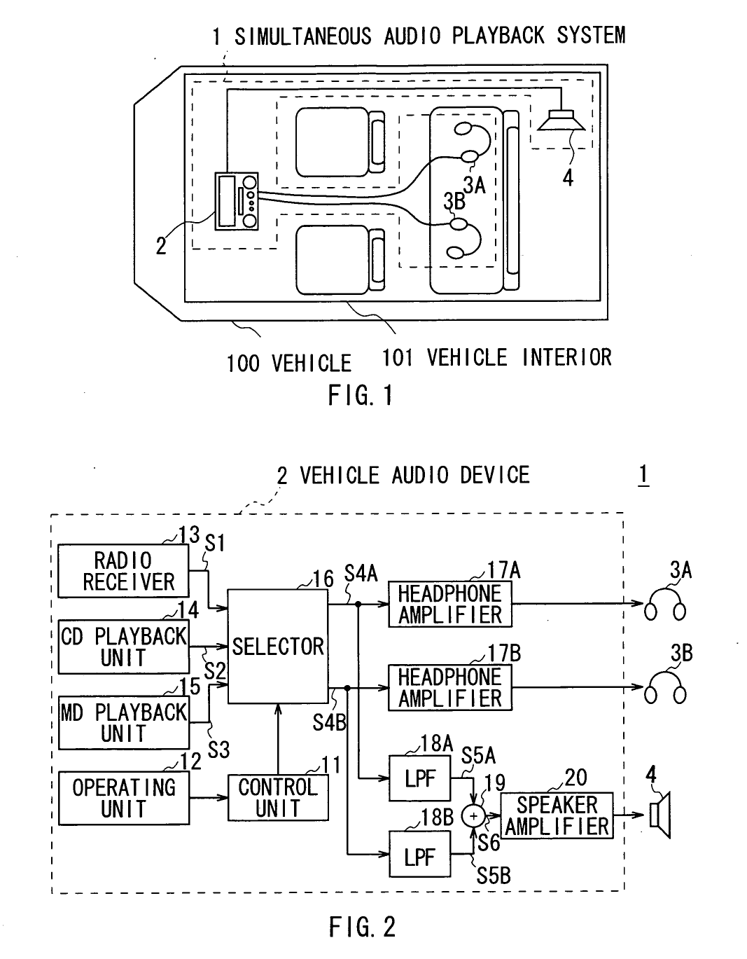

Referring to FIG. 1, reference numeral 1 shows a construction of a simultaneous audio playback system according to this invention, where a vehicle audio device 2 with headphones 3A and 3B and a subwoofer 4 is mounted inside the vehicle interior 101 of a vehicle 100.

The vehicle audio device 2 outputs different audio signals to the headphones 3A and 3B, thereby allowing users wearing the headphones 3A and 3B to listen to the different sounds. In addition, the vehicle audio device 2 outputs a bass signal to the subwoofer 4, thereby allowing the users to directly listen to the bass sound.

Note that, since bass sound has low directionality, every user can listen to the bass sound from the subwoofer 4 even if this subwoofer 4 is mounted at any place of the vehicle interior 101.

(1-2) Construction of Simultaneous Audio Playback Device

Referring to FIG. 2, the vehicle audio device 2 is entirely controlled by a control unit 11, and receives requests from users via an operating unit 12, such as selection of an audio source including a compact disc (CD) or a Mini Disc (MD), and adjustment of volume.

A radio receiver 13 receives radio broadcasting waves and creates an audio signal S1. A CD playback unit 14 plays a CD and creates an audio signal S2. An MD playback unit 15 plays an MD and creates an audio signal S3. These signals are given to a selector 16.

The selector 16 selects an audio signal S1, S2 or S3 in response to a request from each user, and sends the selected signal to a headphone amplifier 17A, 17B and a lowpass filter (LPF) 18A, 18B as an audio signal S4A, S4B.

The headphone amplifier 17A, 17B amplifies and sends the audio signal S4A, S4B to the headphone 3 (3A, 3B), thus outputting user desired sound (hereinafter, referred to as selected sound) from the headphone 3 (3A, 3B).

The headphone 3 generally cannot output high quality bass sound but outputs midrange and treble sound.

The lowpass filter 18A, 18B extracts only bass components (for example, 150 Hz or lower components) from the audio signal S4A, S4B received from the selector 16, and creates and sends a bass signal S5A, S5B to a mixer 19.

The mixer 19 creates a mixed bass signal S6 by mixing the received bass signals S5A and S5B, and sends it to a speaker amplifier 20.

The speaker amplifier 20 amplifies and sends the received mixed bass signal S6 to the subwoofer 4, thereby outputting the mixed bass sound from the subwoofer 4.

Note that each of the headphone amplifiers 17A and 17B and the speaker amplifier 20 is designed to adjust the volume of an audio signal to be output, in response to a request from a user via the operating unit 12.

As described above, the vehicle audio device 2 outputs the midrange and treble sounds of selected sounds via the headphones 3A and 3B, and also outputs mixed bass sound created by mixing the bass components of the selected sounds selected by all users, via the subwoofer 4.

### (2) User Listening of Selected Sound

By the way, as described above, each user listens to the midrange and treble sound of his/her selected sound via the headphone 3 in the vehicle interior 101.

At the same time, the user directly listens to mixed bass sound from the subwoofer 4. In other words, the user hears the bass components of sounds (hereinafter, referred to as unselected sounds) selected by the other users, in addition to the bass components of his/her selected sound.

Generally, humans can unconsciously distinguish only desired sound from noises. This is called a cocktail-party effect.

Therefore, although the subwoofer outputs mixed bass sound, each user can unconsciously distinguish only bass components which match the rhythm and tempo of the midrange and treble sound that he/she is listening to via the headphone 3, that is, the bass sound of his/her selected sound.

As to the bass components of unselected sounds that do not match the rhythm and tempo of the midrange and treble sound that the user is listening to, he/she can unconsciously half-listens to them as noises.

That is, each user can simultaneously listens to the midrange and treble sound of his/her selected sound via the headphone 3 and the bass sound of the selected sound via the subwoofer 4. As a result, the user can listen to high quality selected sound including bass sound, without being distracted by the bass components of unselected sounds.

### (3) Operations and Effects

According to the above configuration, in response to users' selections of audio sources, the vehicle audio device 2 individually outputs the midrange and treble sounds of the selected sounds to the corresponding users via the headphones 3 and also outputs mixed bass sound created by mixing the bass components of all users' selected sounds, from the subwoofer 4.

At this time, although each user hears mixed bass sound mixing the bass components of selected and unselected sounds, he/she can unconsciously distinguish the bass sound of the selected sound that matches the rhythm and tempo of the midrange and treble sound of the selected sound that he/she is listening to via the headphone 3.

As to the bass sounds of the unselected sounds that do not match the rhythm and tempo of the selected sound that the user is listening to via the headphone 3, the user can unconsciously half-listen to them as noises like outside noises.

As a result, the vehicle audio device 2 allows each user to listen to both the midrange and treble sound of his/her selected sound from the headphone 3 and the bass sound of the selected sound from the subwoofer 4, that is, good quality selected sound including the bass sound.

In this case, the vehicle audio device 2 is designed to output the bass sounds of all users' selected sounds from one subwoofer 4. Therefore, many devices for individually outputting the bass sounds to different users are not required, resulting in allowing each user to listen to the bass sound of his/her selected sound with a simple construction.

According to the above configuration, the vehicle audio device 2 outputs the midrange and treble sound of user selected sound from the headphone 3 and also outputs mixed bass sound mixing the bass components of all users' selected sounds from the subwoofer 4. As a result, each user can listen to the midrange and treble sound of his/her selected sound and also can unconsciously distinguish only the bass sound of the selected sound from the mixed bass sound, thereby being capable of listening to good quality selected sound including bass sound. That is, a plurality of users can listen to different sounds with high sound quality.

### (4) Other Embodiments

Note that the above embodiment has described a case where an output level of mixed bass sound is fixed. This invention, however, is not limited to this and the output level of mixed bass sound can be changed according to a surrounding noise level.

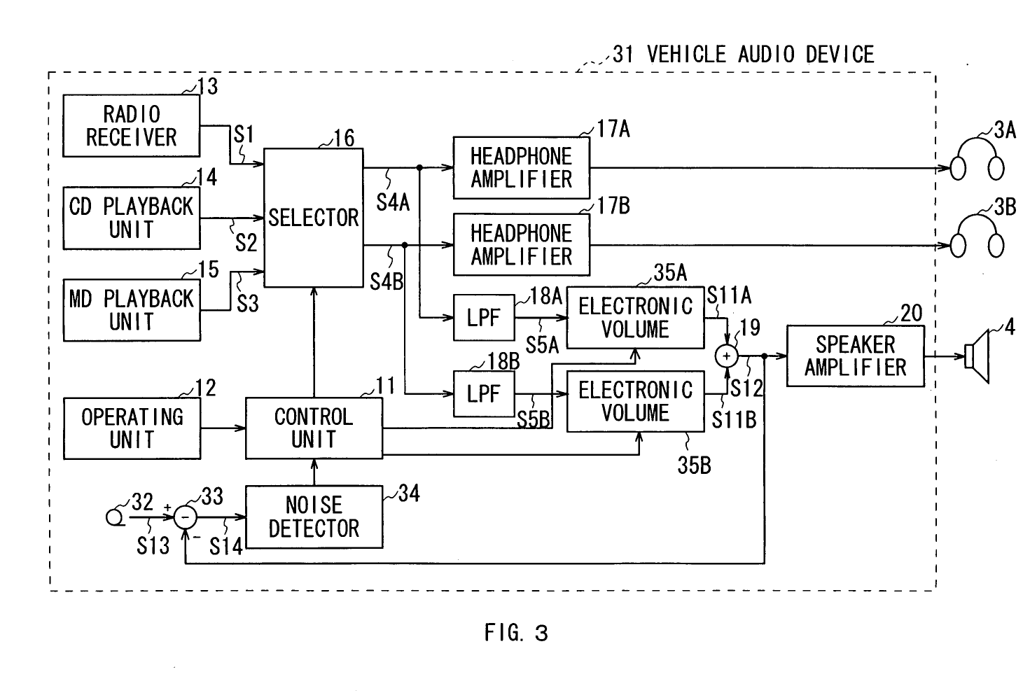

That is, in FIG. 3 where the same reference numerals are applied to parts corresponding to those of FIG. 2, a vehicle audio device 31 of a simultaneous audio playback system 30 outputs the midrange and treble sound of user selected sound via a headphone 3 (3A, 3B).

A lowpass filter 18A, 18B extracts only the bass components from an audio signal S4A, S4B received from a selector 16, and creates and gives a bass signal S5A, S5B to an electronic volume 35A, 35B.

The electronic volume 35A, 35B changes the signal level of the bass signal S5A, S5B under the control of a control unit 11 and gives the resultant as a bass signal S11A, S11B to a mixer 19.

The mixer 19 creates a mixed bass signal S12 by mixing the received bass signals S11A and S11B, and sends this to a speaker amplifier 20 and a subtractor 33.

The speaker amplifier 20 amplifies and sends the received mixed bass signal S12 to a subwoofer 4, thereby outputting the mixed bass sound from the subwoofer 4.

A microphone 32, on the other hand, collects sounds inside a vehicle interior 101 and converts it into an electric signal, and creates and sends an in-vehicle audio signal S13 to the subtractor 33. This in-vehicle audio signal S13 includes outside noises and the mixed bass sound output from the subwoofer 4.

The subtractor 33 subtracts the mixed bass signal S12 from the in-vehicle audio signal S13 to create a noise signal S14 for only noises inside the vehicle interior 101, and sends this to a noise detector 34.

The noise detector 34 detects a noise level based on the noise signal S14, creates a noise level signal S15 and sends this to the control unit 11.

At this time, the control unit 11 controls the electronic volumes 35A and 35B based on the noise level signal S15 to change the signal levels of the bass signals S11A and S11B.

That is, the vehicle audio device 31 changes the volume level of the mixed bass sound to be output from the subwoofer 4, based on the noise level detected by the noise detector 34.

Therefore, each user can listen to the mixed bass sound at a volume which is automatically adjusted so that the bass sound is not lost in the noises of which the volume always vary.

In this connection, not only the volume level of the mixed bass sound, the vehicle audio device 31 can change the volume of the midrange and treble sound of selected sound to be output from the headphone 3 based on the noise level detected by the noise detector 34.

The above embodiment has described a case where each user listens to the midrange and treble sound of his/her selected sound via the headphone 3. This invention, however, is not limited to this and can allow each user to listen to the midrange and treble sound of his/her selected sound with another technique such as mounting a head-rest speaker (not shown) in a seat of the vehicle 100 (FIG. 1) and outputting selected sound.

Further, the above embodiment has described a case where two headphones 3 are connected to the vehicle audio device 2. This invention, however, three or more headphones can be connected. In this case, mixed bass sound is created and output based on selected sounds selected by all users.

Furthermore, the above embodiment has described a case where one subwoofer 4 is connected to the vehicle audio device 2 via the speaker amplifier 20. This invention, however, is not limited to this and a plurality of speaker amplifiers 20 may be connected in parallel and subwoofers 4 may be connected to them in case where mixed bass output is insufficient.

Furthermore, the above embodiment has described a case where a user selects radio, CD, or MD as an audio source. This invention, however, is not limited to this and the user can select another audio source such as a hard disk drive, television broadcasting, or DVD.

In this connection, the vehicle audio device can be designed to simultaneously output different audio signals with a time-division readout technique for a case where a plurality of users select different audio tacks of the same hard disk drive or CD.

Furthermore, the above embodiment has described a case where this invention is applied for the vehicle interior 101 of the vehicle 100. This invention, however, is not limited to this and can be applied to a case where a plurality of users listen to different sounds from different audio sources in the same place such as a train, airplane, house, or tearoom.

Furthermore, the above embodiment has described a case where the vehicle audio device as a simultaneous audio playback device is composed of a selector 16 as an audio signal selection means, headphone amplifiers 17A and 17B as individual audio signal output means, and the mixer 19 and the speaker amplifier 20 as a mixed bass signal output means. This invention, however, is not limited to this and the simultaneous audio playback device can have another circuitry including an audio signal selection means, individual audio signal output means and a mixed bass signal output means.

This invention can be applied to other kinds of audio devices including in-house audio devices, other than the vehicle audio device 2.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

1. A simultaneous audio playback device comprising:
audio signal selection means for selecting audio signals corresponding to requests from a plurality of users, out of plural kinds of audio signals;
individual audio signal output means for individually outputting the selected audio signals to corresponding the plurality of users; and
mixed bass signal output means for outputting a mixed bass signal created by extracting and mixing only bass components of the selected audio signals, to all of the plurality of users.

2. The simultaneous audio playback device according to claim 1, further comprising
noise level detection means for detecting a noise level of outside noises, wherein
the mixed bass signal output means changes an output level of the mixed bass signal according to the noise level.

3. A simultaneous audio playback method comprising:
an audio signal selection step of selecting audio signals corresponding to requests from a plurality of users, out of plural kinds of audio signals;
an individual audio signal output step of individually outputting the selected audio signals to corresponding the plurality of users; and
a mixed bass signal output step of outputting a mixed bass signal created by extracting and mixing only bass components of the selected audio signals, to all of the plurality of users.

4. A simultaneous audio playback system comprising:
audio signal selection means for selecting audio signals corresponding to requests from a plurality of users, out of plural kinds of audio signals;
individual audio signal output means for individually outputting the selected audio signals to corresponding the plurality of users;
mixed bass signal output means for outputting a mixed bass signal created by extracting and mixing only bass components of the selected audio signals, to all of the plurality of users;
individual audio output means for individually outputting the selected audio signals as sound; and
mixed bass output means for outputting the mixed bass signal as sound.

5. A vehicle with a simultaneous audio playback system comprising:
audio signal selection means for selecting audio signals corresponding to requests from a plurality of users, out of a plurality of audio signals;
individual audio signal output means for individually outputting the selected audio signals to corresponding the plurality of users;
mixed bass signal output means for outputting a mixed bass signal created by extracting and mixing only bass components of the selected audio signals, to all of the plurality of users;
individual audio output means for individually outputting the selected audio signals as sound; and
mixed bass output means for outputting the mixed bass signal as sound.
